(19) United States
(12) Patent Application Publication
(10) Pub. No.: US 2007/0007484 A1
(43) Pub. Date: Jan. 11, 2007

(54) Sliding valve, in particular quick-acting sliding valve for an explosion protection shut-off device

(76) Inventor: Jurg Zellweger, Waldstatt (CH)

Correspondence Address: NATH & ASSOCIATES, 112 South West Street, Alexandria, VA, 22314, US

(21) Appl. No.: 10/569,628

(22) PCT Filed: Jun. 28, 2004
(86) PCT No.: PCT/CH04/00399

§ 371 Date: Feb. 27, 2006

(30) Foreign Application Priority Data
Aug. 29, 2003 (CH) 1476/03

(51) Int. Cl. F16K 3/00

(52) U.S. Cl. 251/327

(57) ABSTRACT

A slide plate (4) with a slide opening (5), which releases an aperture opening is mounted in a slide housing (2) with the aperture opening (3). The slide plate is sealed in each operating position by elastically deformable sealing rings (7a, 7a′, 7b, 7b′) which are arranged in circumferential grooves (6a, 6a′, 6b, 6b′) and, surrounding the aperture opening (3), act on both faces of the slide plate (4). The inner edge (8) of the slide opening (5) is designed such that it tapers towards the center (21) with respect to the wall thickness of the slide plate. This prevents the inner edge from being able to damage the sealing rings, or even to push them out, during movement to the closed position.

The invention relates to a slide, in particular a fast closure slide for an explosion protection barrier apparatus as claimed in the precharacterizing clause of claim 1. These so-called disk closure slides are used in particular for media to be conveyed which are in the form of gases, dust or for awkward liquid or pasty feed media, because the area around the aperture opening remains sealed when the slide plate is in the open and closed operating positions. This slide type is thus particularly highly suitable for use as a fast closure slide for an explosion protection barrier apparatus. In this case, when an explosion occurs in a feed line (for example a dust or gas explosion), the feed line is intended to be closed within a very short time in order to prevent propagation of the pressure shock wave, and possibly fire wave, in the installation.

One problem with comparable slide types of this generic type is obviously that the slide plate must be sealed as effectively as possible and with as little wear as possible. DE-U 202 09 420 has disclosed an isolating slide in which the sealing means are in the form of rigid, annular sealing pistons which are held in annular fluid cylinders and can be pressed by a pressure medium against the slide plate. In this case, those contact surfaces of the sealing bodies which face the slide and those contact surfaces of the slide plate which interact with them to form a seal are provided with a hard material layer, which is harder than the material of the slide plate. The aim of this measure is to ensure that the seal does not relax over time, even in the case of difficult fluids, without any significant wear to the sealing means.

A design such as this is obviously highly complex and is thus associated with high costs. Furthermore, the design for a fast closure slide is, in particular, extremely unsuitable in an explosion protection barrier apparatus. This is because fast closure slides are always in the open position in normal operating conditions, and are closed only in emergencies. Subject to these preconditions, it is complex to permanently connect a pressure medium piston, as the sealing means, to a pressure medium system.

One object of the invention is thus to provide a slide of the type mentioned initially in which the problem of excessive wear or even damage to the sealing means is solved with the use of conventional sealing means, and which can be cleaned using a cleaning liquid or using steam. According to the invention, this object is achieved by a slide which has the features in claim 1.

Soft annular seals are excellently suitable for sealing the slide plate, particularly in the case of gaseous feed media. However, one disadvantage of seals such as these is that they are sensitive to mechanical influences which act tangentially, as is the case during movement of the slide plate. As the slide opening slides past, the elastic sealing rings expand and there is even a risk of the sealing rings being pushed out of their bearing groove. The inner edge of the slide opening, which tapers towards the center, optimally ensures in a simple manner that the sealing rings remain in their bearing grooves and cannot be damaged during the relative movement of the slide plate.

It is particularly advantageous for the inner edge to be designed with a cross section which tapers in a wedge shape, with the wedge surfaces preferably including an angle of 4° to 90°. The wedge shape is in this case preferably designed to be symmetrical with respect to the center plane of the slide plate. However, an asymmetric wedge shape would also be feasible in certain cases. Furthermore, it is expedient for the wedge shape to be truncated in the area of the smallest internal diameter. The truncation may in this case be rounded, or may run in a straight line. In certain cases, it would, however, even be feasible for the wedge shape to be designed like a blade, without any truncation. In a case such as this, solid bodies located in the area of the blade of the slide plane would be cut through during the closing process.

The sealing effect can be improved by arranging two sealing rings concentrically with respect to one another at least on one face of the slide plate. However, the same sealing means are preferably arranged on both faces of the slide plate.

The aperture opening may be formed by coaxial tubular pieces, in particular tubular connecting pieces, whose mutually facing end faces hold the slide plate between them, with the sealing rings being arranged on the end faces. These tubular pieces could also directly be the end sections of the feed lines. These tubular pieces may be held detachably on the slide housing, which has the advantage that the state of the seals can be checked relatively easily by removal of the tubular pieces.

In one alternative refinement, the tubular pieces are held on the slide housing such that their relative position with respect to the slide plate can be moved. This obviously allows the adjustment depth and thus the contact force of the sealing rings against the slide plate to be set exactly.

The slide housing may have in each case one flange with an internal thread on each face of the slide plate, in which case the tubular pieces, which are provided with an external thread, are screwed into the flanges. A thread connection such as this allows the adjustment depth to be set particularly well. The selected thread position is secured by conventional securing means. However, in general, it would of course also be feasible for the circumferential sealing rings to be placed at a different point on the slide housing, for example on the end faces of the flanges that have been mentioned.

Further individual features and advantages of the invention will become evident from the exemplary embodiment which is described in the following text and from the drawings, in which:

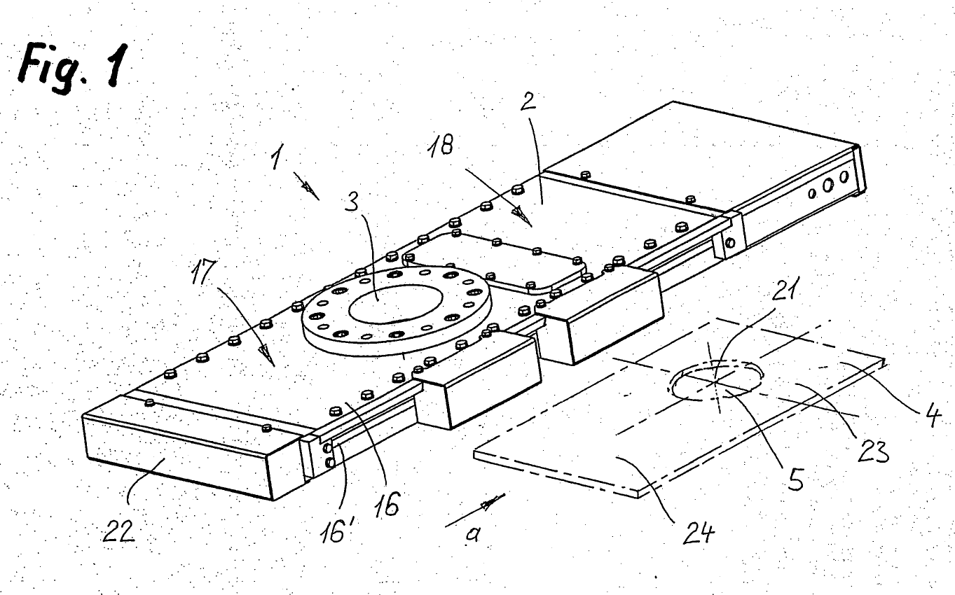

FIG. 1: shows a perspective external view of a slide,

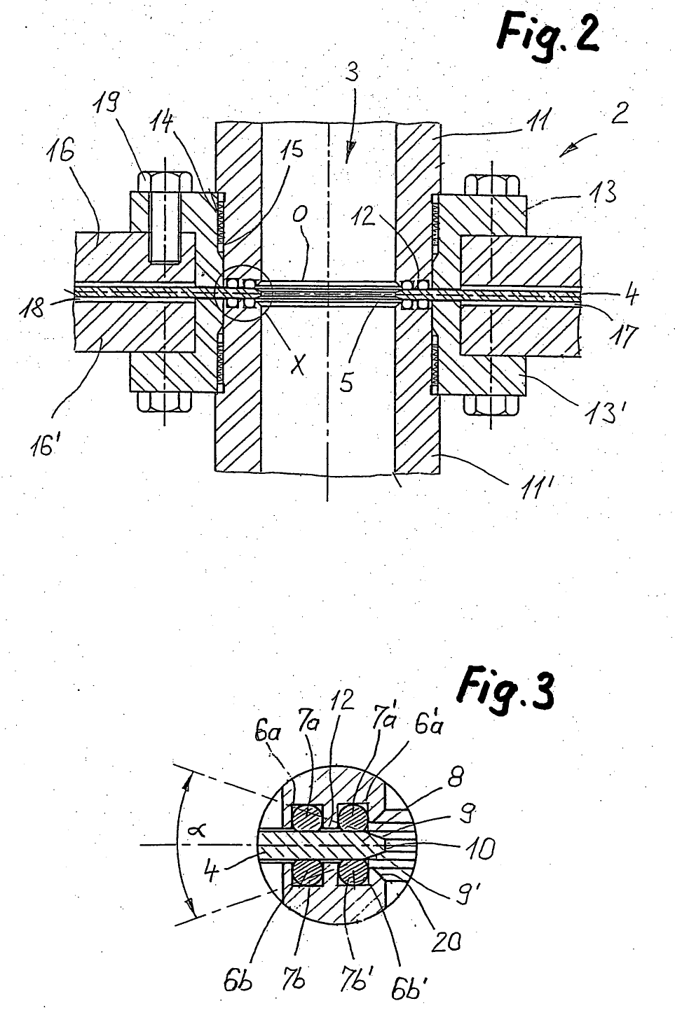

FIG. 2: shows a partial cross section through the slide housing with the slide in the open position,

FIG. 3: shows the detail X from FIG. 2,

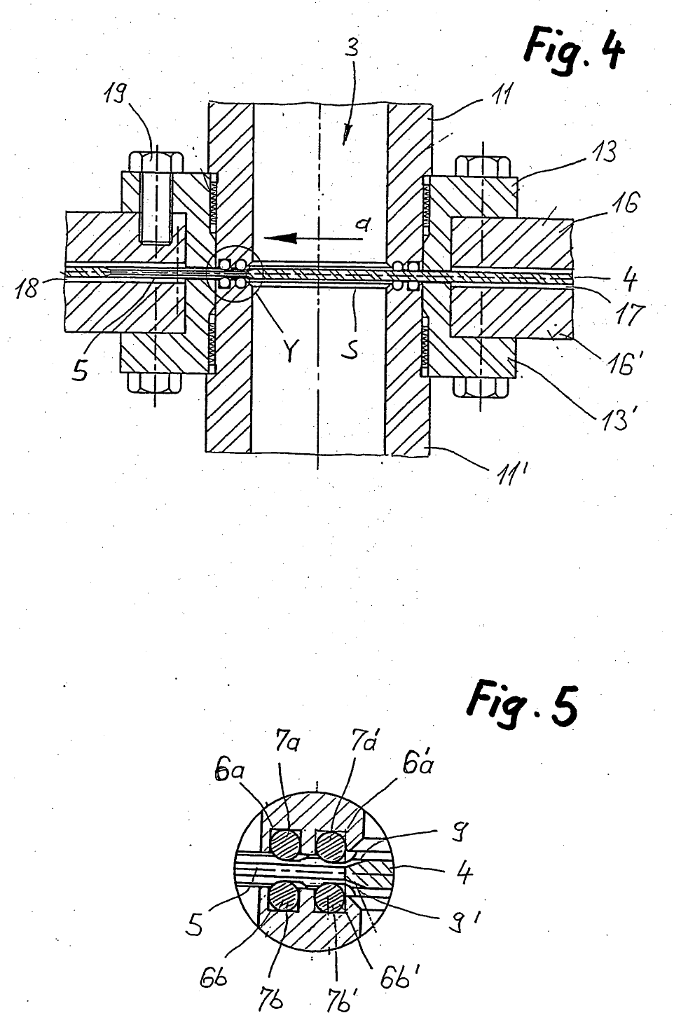

FIG. 4: shows a partial cross section through the slide housing with the slide in the closed position, and

FIG. 5: shows the detail Y from FIG. 4.

As can be seen from FIG. 1, the slide, which is annotated in general by 1, comprises a slide housing 2 which forms an aperture opening 3. The slide housing is designed to be rectangular and essentially comprises the housing plates 16 and 16′, which are held at a distance from one another. The slide plate 4, which cannot be seen from the outside, is mounted between these two plates such that it can be moved linearly. In order to assist understanding, the slide plate is illustrated by dashed-dotted lines as a side projection.

The slide plate 4 has a slide opening 5 with a center 21 which, when in the open position, corresponds with the aperture opening 3 on the slide housing. In the exemplary embodiment, 22 is the drive side with a slide drive, which is not illustrated in any more detail. However, the drive could also be arranged at the opposite end of the slide housing 2, or on both sides.

When the slide plate is moved in the closing direction a, that section 23 of the slide plate with the slide opening 5 is moved into a holding area 18 between the two housing plates 16 and 16′. The aperture opening 3 is then closed by the remaining section 24 of the slide plate 4. In the illustrated, open position, this remaining section 24 is located in an opposite holding area 17. The slide plate 4 is moved by drive means, which are not illustrated in any more detail here, for example via a pneumatic drive. In the case of explosion protection barrier apparatuses, propellant charges are also used to close the slide and are detonated on initiation. For this purpose, pressure sensors are arranged upstream, and close the fast closure slide within a few milliseconds in the event of an explosion, and in any case before the arrival of the shock wave. However, those skilled in the art are familiar with these drive mechanisms.

FIGS. 2 and 3 show a partial cross section of the slide shown in FIG. 1 in the area of the slide plate in the open position O. The aperture opening 3 is formed by the tubular pieces 11, 11′, whose end faces 12 face one another and also have circumferential grooves 6, 6a′ and 6b, 6b′. O-rings 7a, 7a′ and 7b, 7b′ composed of elastic material are held in these grooves. The tubular pieces 11, 11′ are provided with an external thread 15 in the end section. The tubular pieces can be screwed on these external threads into the internal thread 14 in the flanges 13, 13′, with the flanges 13, 13′ being attached to the two housing plates 16, 16′ by means of attachment screws 19. The depth to which the tubular pieces 11, 11′ are screwed in is chosen such that the O-rings 7a, 7a′ and 7b, 7b′ are pressed against the slide plate 4 with the desired contact force.

As can be seen in particular from FIG. 3, the inner edge 8 of the slide opening 5 has a wedge-shaped incline with the wedge surfaces 9, 9′. These include an angle a of about 40° between them. A hollow cylindrical truncation 10 is arranged in the area of the smallest internal diameter of the slide opening. As can be seen, the wedge-shaped taper is designed in such a way that the inner sealing rings 7a′, 7b′ still rest on the maximum wall thickness of the slide plate 4. Furthermore, the end faces 12 of the tubular pieces 11, 11′ are provided with an incline 20 in the area of the aperture opening 3 in order as far as possible to avoid any dead spaces in which solid substances could accumulate. The opened slide can thus be cleaned relatively easily at any time by a cleaning liquid or by steam.

FIGS. 4 and 5 show the release of the slide to the closed position S. In this case, the slide plate 4 is moved in the direction of the arrow a towards the holding area 18. FIG. 5 shows the position of a slide plate 4 shortly before reaching the final position. The sealing rings 7a, 7a′ and 7b, 7b′ can admittedly expand somewhat as they move over the slide opening 5, but they are pushed back again by the wedge surfaces 9, 9′ carefully into the grooves 6a, 6a′, 6b, 6b′ thus preventing any damage, or them even being pushed out. When the closed position has been reached completely, the sealing rings 7a, 7a′, 7b, 7b′ once again rest exclusively on the maximum wall thickness of the slide plate 4. This ensures that, when the fast closure slide is released, no medium can emerge via a seal which may have been damaged or pushed out.

After the release of the fast closure slide, all the components can in any case be checked to determine whether they have been damaged. This is made considerably easier by the tubular pieces 11, 11′ which can be unscrewed. As can be seen, the slide plate in the embodiment according to the invention is guided between the circumferential seals 7a, 7a′, 7b, 7b′. When the shock wave strikes the closed slide plate, the sealing rings are loaded on one face of the slide plate, without any load on the other face. However, if the sealing rings are correctly prestressed, absolute sealing is ensured even in this case provided that the slide plate 4 is pressed against the end face 12 of a tubular piece 11 or 11′.

It is particularly advantageous for the slide housing to be provided with a heat-resistant coating, which preferably seals the surface, on the inner face, and/or for the slide plate to be provided with such a coating at least in places. By way of example, a polytetrafluoroethylene (PTFE) such as TEFLONS® may be used as the coating material. When gas generators are used as the valve drive, it has been found that the heat wave that is created on ignition heats the surface of the metal parts up to 800° C. During this process, a sticky film, which can be removed only with difficulty, is created together with moisture residues on the metal surface. The heat-resistant coating on the one hand prevents moisture from entering the microstructure of the metal surface, while on the other hand acting as a thermal brake. In this case, the surfaces remain clean even after the gas generator has been released a number of times, and powder residues cannot accumulate. This coating could highly advantageously also be used on other fast closure valves using a gas generator as the drive.

1. A slide, in particular a fast closure slide (1) for an explosion protection barrier apparatus, having a slide housing (2) which contains an aperture opening (3), and having a slide plate (4) which has a slide opening (5) which releases the aperture opening (3), and which slide plate (4) can be moved in the slide housing (2) between an open position (0) and a closed position (S), with the slide plate (4) being sealed in each operating position by annular sealing means which, surrounding the aperture opening, act on the slide plate on both faces of the slide plate, characterized in that the sealing means are elastically deformable sealing rings (7a, 7a′, 7b, 7b′) which are arranged in circumferential grooves (6a, 6a′, 6b, 6b′), and in that the inner edge (8) of the slide opening (5) tapers towards the center with respect to the wall thickness of the slide plate.

2. The slide as claimed in claim 1, characterized in that the inner edge (8) tapers with a wedge-shaped cross section, with the wedge surfaces (9, 9′) preferably including an angle (a) of 4° to 90°.

3. The slide as claimed in claim 2, characterized in that the wedge shape is truncated in the area of the smallest internal diameter.

4. The slide as claimed in claim 1, characterized in that two sealing rings (7a, 7a′, 7b, 7b′) are arranged concentrically with respect to one another on at least one face of the slide plate.

5. The slide as claimed in claim 1, characterized in that the aperture opening (3) is formed by coaxial tubular pieces (11, 11′), whose mutually facing end faces (12) hold the slide plate (4) between them, and in that the sealing rings (7a, 7a′, 7b, 7b′) are arranged on the end faces.

6. The slide as claimed in claim 5, characterized in that the tubular pieces (11, 11′) are held detachably on the slide housing (2).

7. The slide as claimed in claim 5, characterized in that the tubular pieces (11, 11′) are held on the slide housing such that their relative position with respect to the slide plate (4) can be moved.

8. The slide as claimed in claim 7, characterized in that the slide housing (2) has in each case one flange (13, 13′) with an internal thread (14) on each face of the slide plate (4), and in that the tubular pieces, which are provided with an external thread (15), are screwed into the flanges.

9. The slide as claimed in claim 1, characterized in that the slide housing (2) is provided, with a heat-resistant coating on the inner face, and/or the slide plate (4) is provided with a heat-resistant coating at least in places.
